(19) United States
(12) Patent Application Publication
(10) Pub. No.: US 2026/0288145 A1
(43) Pub. Date: Sep. 24, 2026

(54) LOCAL GOAL DETERMINATION APPARATUS, METHOD, AND SYSTEM FOR NON-PRECISION MAP-BASED DRIVING

(71) Applicants: HYUNDAI MOTOR COMPANY, Seoul (KR); Kia Corporation, Seoul (KR)

(72) Inventors: Kyungzun RIM, Gyeonggi-do (KR); Jaeoh LEE, Gyeonggi-do (KR); Chung Hyuk KANG, Gyeonggi-do (KR)

(21) Appl. No.: 19/401,762

(22) Filed: Nov. 26, 2025

(30) Foreign Application Priority Data
Mar. 24, 2025 (KR) 10-2025-0037259

(51) Int. Cl. G05D 1/246; G05D 1/229; G05D 1/242; G05D 1/248

(52) U.S. Cl. CPC G05D 1/2469; G05D 1/229; G05D 1/242; G05D 1/248

(57) ABSTRACT

A local goal determination method for non-precision map-based driving includes: receiving a current position and direction of the robot, a plurality of way points to a destination, and an adjacent drivable area; determining a driving direction in which the robot proceeds based on the received current position and direction of the robot, and the way points; determining the plurality of local goal candidate positions based on the current position of the robot within the received adjacent drivable area; calculating long-range geometry information using the sensor information; evaluating each of the plurality of local goal candidate positions based on the long-range geometry information and the driving direction and calculating an evaluation score; and determining a local goal candidate position with the largest calculated evaluation score as the local goal.

### CROSS-REFERENCE TO RELATED APPLICATION

This application claims priority to and the benefit of Korean Patent Application No. 10-2025-0037259, filed with the Korean Intellectual Property Office on Mar. 24, 2025, the entire contents of which are incorporated herein by reference.

### TECHNICAL FIELD

The present disclosure relates to a local goal determination apparatus, method, and system for non-precision map-based driving, and more particularly, to a local goal determination apparatus, method, and system for non-precision map-based driving, which can determine a local goal by referring to a current position of a robot driving based on a non-precision map.

### BACKGROUND

A precise map may be generated using images or LiDAR and used to find a position and a path of a mobile apparatus. In some cases, the precise map, especially for a new space, may be generated with relatively large cost and resource.

### SUMMARY

The present disclosure describes a technology that enables driving using a relatively simple map (e.g., Open Street Map) and sensor information.

The present disclosure describes a local goal determination apparatus, method, and system for non-precision map-based driving capable of allowing a person or a robot to drive using GPS and sensor information based on a non-precision map without creating a precise map in an outdoor service field.

The present disclosure describes a local goal determination apparatus, method, and system for non-precision map-based driving capable of determining a local goal that is a short-term movement target point, based on a local goal candidate position from a current position, long-range geometry information, and a driving direction in which a robot should go, when a person or a robot drives based on a non-precision map.

According to one aspect of the subject matter described in this application, a local goal determination apparatus for driving a robot based on a non-precision map includes one or more processors and one or more memory devices storing a program code configured to, based on being executed by the one or more processors, cause the local goal determination apparatus to perform operations. The operations include receiving a current position of the robot, a current direction of the robot, a plurality of way points to a destination, and an adjacent drivable area, determining a driving direction for the robot to proceed based on the current position of the robot, the current direction of the robot, and the plurality of way points, determining a plurality of local goal candidate positions within the adjacent drivable area based on the current position of the robot, calculating long-range geometry information using sensor information, evaluating each of the plurality of local goal candidate positions based on the long-range geometry information and the driving direction to determine an evaluation score of each of the plurality of local goal candidate positions, and determining, as a local goal of the robot, one of the plurality of local goal candidate positions that has a greatest evaluation score among the evaluation scores of the plurality of local goal candidate positions.

Implementations according to this aspect can include one or more of the following features. For example, the current position of the robot can be an estimated current position of the robot, where determining the driving direction can include, based on (i) the estimated current position of the robot and (ii) an error between the estimated current position of the robot and an actual current position of the robot, determining the driving direction based on way points among the plurality of way points that are located within a preset radius from the estimated current position.

In some implementations, determining the driving direction further can include multiplying angular distributions of the plurality of way points, each of the angular distributions corresponding to a normal distribution based on (i) a mean of an angle between the current direction of the robot and a line connecting the estimated current position and one of the way points within the preset radius and (ii) a standard deviation of the angle.

In some implementations, determining the plurality of local goal candidate positions can include receiving a local drivable area map, setting a default drivable area of the robot, coupling the local drivable area map and the default drivable area to generate the adjacent drivable area, determining a contour of the adjacent drivable area, and determining the plurality of local goal candidate positions among contour points of the contour. In some examples, setting the default drivable area of the robot can include setting, as the default drivable area, a rhombus-shaped area having vertices that are disposed at front, straight left, straight right, and straight rear positions of the robot.

In some examples, determining the plurality of local goal candidate positions among the contour points can include adding, in the plurality of local goal candidate positions, (i) vertices of a contour polygon defined by the contour and (i) a point interpolated between the vertices based on a distance between the vertices being greater than or equal to a reference limit distance.

In some implementations, calculating the long-range geometry information can include generating a point cloud within a reference radius area based on the current position of the robot using a LIDAR sensor, dividing the reference radius area into a plurality of areas, calculating an average distance from the current position of the robot to the point cloud for each of the plurality of areas, and determining the average distance as a length of a reference radius for a specific area that does not include the point cloud among the plurality of areas.

In some implementations, evaluating each of the plurality of local goal candidate positions can include, for each of the plurality of local goal candidate positions, estimating a geometry factor by interpolating the long-range geometry information, for each of the plurality of local goal candidate positions, calculating an effective angle by subtracting an angle of the current direction relative to a reference direction from an angle of the driving direction relative to the reference direction, calculating an effective distance between the robot and one of the plurality of local goal candidate positions projected in the driving direction based on (i) an actual distance between the robot and the one of the plurality of local goal candidate positions and (ii) the effective angle, and calculating the evaluation score for each of the plurality of local goal candidate positions by multiplying the geometry factor and the effective distance.

According to another aspect, a local goal determination method is provided for driving a robot based on a non-precision map. The method is performed by a computing device comprising a processor and a memory. The method includes receiving a current position of the robot, a current direction of the robot, a plurality of way points to a destination, and an adjacent drivable area, determining a driving direction for the robot to proceed based on the current position of the robot, the current direction of the robot, and the plurality of way points, determining a plurality of local goal candidate positions within the adjacent drivable area based on the current position of the robot, calculating long-range geometry information using sensor information, evaluating each of the plurality of local goal candidate positions based on the long-range geometry information and the driving direction to determine an evaluation score of each of the plurality of local goal candidate positions, and determining, as a local goal of the robot, one of the plurality of local goal candidate positions that has a greatest evaluation score among the evaluation scores of the plurality of local goal candidate positions.

Implementations according to this aspect can include one or more of the following features. For example, the current position of the robot can be an estimated current position of the robot, where determining the driving direction can include determining the driving direction based on way points among the plurality of way points that are located within a preset radius from the estimated current position based on an error between the estimated current position of the robot and an actual current position of the robot.

In some implementations, determining the driving direction further can include multiplying angular distributions of the plurality of way points, each of the angular distributions corresponding to a normal distribution based on (i) a mean of an angle between the current direction of the robot and a line connecting the estimated current position and one of the way points within the preset radius and (ii) a standard deviation of the angle.

In some examples, determining the plurality of local goal candidate positions can include receiving a local drivable area map, setting a default drivable area of the robot, coupling the local drivable area map and the default drivable area to generate the adjacent drivable area, determining a contour of the adjacent drivable area, and determining the plurality of local goal candidate positions among contour points of the contour. In some examples, setting the default drivable area of the robot can include setting, as the default drivable area, a rhombus-shaped area having vertices that are disposed at front, straight left, straight right, and straight rear positions of the robot.

In some examples, determining the plurality of local goal candidate positions among the contour points can include adding, in the plurality of local goal candidate positions, (i) vertices of a contour polygon defined by the contour and (i) a point interpolated between the vertices based on a distance between the vertices being greater than or equal to a reference limit distance.

In some implementations, calculating the long-range geometry information can include generating a point cloud within a reference radius area based on the current position of the robot using a LIDAR sensor, dividing the reference radius area into a plurality of areas, calculating an average distance from the current position of the robot to the point cloud for each of the plurality of areas, and determining the average distance as a length of a reference radius for a specific area that does not include the point cloud among the plurality of areas.

In some examples, evaluating each of the plurality of local goal candidate positions can include, for each of the plurality of local goal candidate positions, estimating a geometry factor by interpolating the long-range geometry information, calculating an effective angle by subtracting an angle of the current direction relative to a reference direction from an angle of the driving direction relative to the reference direction, calculating an effective distance between the robot and each of the plurality of local goal candidate positions projected in the driving direction based on (i) an actual distance between the robot and one of the plurality of local goal candidate positions and (ii) the effective angle, and calculating the evaluation score for each of the plurality of local goal candidate positions by multiplying the geometry factor and the effective distance.

According to another aspect, a local goal determination system for driving a robot based on a non-precision map includes a sensor unit comprising GPS, LiDAR, and a plurality of cameras, and a path planning unit configured to receive the non-precision map, based on the non-precision map and sensor information received from the sensor unit, determine an adjacent drivable area, way points to a destination, and a local goal of the robot, and generate a local path plan based on the local goal. The system further includes a robot control unit configured to control driving of the robot based on the local path plan received from the path planning unit.

Implementations according to this aspect can include one or more of the following features. For example, the path planning unit can include one or more processors configured to estimate a current position of the robot in the non-precision map based on GPS information and to determine the way points to the destination, using the sensor information, determine (i) the adjacent drivable area that is an area available for the robot to travel and (ii) an area that is unavailable for the robot to travel, determine the local goal for the robot based on information on the current position, the way points, and the drivable area, and generate a local path planning for driving to the destination based on the local goal.

In some examples, the one or more processors can be further configured to determine a driving direction for the robot to proceed based on the current position of the robot, a current direction of the robot, and the way points, determine a plurality of local goal candidate positions in the adjacent drivable area based on the current position of the robot, calculate long-range geometry information using the sensor information, evaluate each of the plurality of local goal candidate positions based on the long-range geometry information and the driving direction to determine an evaluation score of each of the plurality of local goal candidate positions, and determine, as the local goal of the robot, one of the plurality of local goal candidate positions that has a greatest evaluation score among the evaluation scores of the plurality of local goal candidate positions.

In some examples, the one or more processors can be further configured to, for each of the plurality of local goal candidate positions, estimate a geometry factor by interpolating the long-range geometry information, calculate an effective angle by subtracting an angle of the current direction relative to a reference direction from an angle of the driving direction relative to the reference direction, calculate an effective distance between the robot and each of the plurality of local goal candidate positions projected in the driving direction based on (i) an actual distance between the robot and one of the plurality of local goal candidate positions and (ii) the effective angle, and calculate the evaluation score for each of the plurality of local goal candidate positions by multiplying the geometry factor and the effective distance.

With the local goal determination apparatus, method, and system for non-precision map-based driving described in the present disclosure, it can be possible to enable the person or robot to drive using only the GPS and sensor information based on the non-precision map without creating the precise map at the outdoor service field.

With the local goal determination apparatus, method, and system for non-precision map-based driving described in the present disclosure, it can be possible to determine the local goal that is the short-term movement target point, based on the local goal candidate position from the current position, the long-range geometry information, and the driving direction for the robot to go along, when the person or robot drives based on the non-precision map.

### BRIEF DESCRIPTION OF THE DRAWINGS

FIG. 1 is a diagram schematically illustrating an example of a local goal determination system for non-precision map-based driving.

FIG. 2 is a block diagram illustrating an example of a local goal determination apparatus for non-precision map-based driving.

FIG. 3 is a flowchart illustrating an example of a local goal determination method for non-precision map-based driving.

FIG. 4 is a diagram for describing an example of a method for determining a driving direction of a robot.

FIG. 5 is a diagram for describing an example of a method for determining a local goal candidate position.

FIG. 6 is a diagram for describing an example of a method for calculating long-range geometry information.

FIG. 7 to FIG. 9 are diagrams for describing an example of a method for evaluating a local goal candidate position and determining a local goal.

FIG. 10 is a diagram for describing an example of a computing device.

### DETAILED DESCRIPTION

Hereinafter, example implementations of the present disclosure will be described more fully with reference to the accompanying drawings so as to be easily practiced by those skilled in the art to which the present disclosure pertains. As those skilled in the art would realize, the described implementations can be modified in various different ways, all without departing from the spirit or scope of the present disclosure. Accordingly, the drawings and description are to be regarded as illustrative in nature and not restrictive. Like reference numerals designate like elements throughout the specification.

Terms such as “ . . . unit”, “ . . . er/or”, and “module” used in the specification can mean a unit capable of processing at least one function or operation described in the specification, which can be implemented as hardware or a circuit, software, or a combination of hardware or circuit and software.

In addition, at least some components or functions of a local goal determination apparatus, method, and system for non-precision map-based driving according to example implementations to be described below can be implemented as a program or software, and the program or software can be stored on a computer-readable medium.

Hereinafter, example implementations of the present disclosure will be described with reference to the drawings.

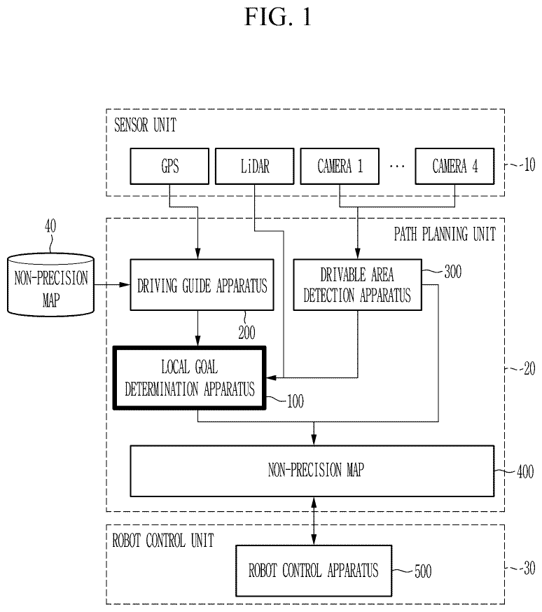

FIG. 1 is a diagram schematically illustrating an example of a local goal determination system for non-precision map-based driving.

The local goal determination system for non-precision map-based driving enables a person or a robot to drive using only GPS and sensor information without creating a precise map in an outdoor service field. In some implementations, the robot may refer to a mobile machine configured to move in a space and perform tasks according to user instructions.

That is, the local goal determination system for non-precision map-based driving uses a simple map, a non-precision map (e.g., open street map (OSM)), instead of a precision map, to find a way point to a destination, selects a local goal based on the way point from the current robot reference, and generates a path planning based on the local goal to drive the robot to the selected destination.

Referring to FIG. 1, a local goal determination system for non-precision map-based driving can include a sensor unit 10, a path planning unit 20, and a robot control unit 30. The sensor unit 10, the path planning unit 20, and the robot control unit 30 can be connected through a network.

The sensor unit 10 can include GPS, LiDAR, and multiple cameras.

The sensor unit 10 can generate sensor information through the GPS, the LiDAR, and the multiple cameras, and provide the sensor information to the path planning unit 20.

In some examples, the sensor information can refer to data collected from the sensor, and is used for the robot to recognize and understand the surrounding environment.

The path planning unit 20 can receive a non-precision map.

The path planning unit 20 can determine a drivable area, a way point to a destination, and a local goal using the received non-precision map and received sensor information, and can generate local path planning based on the local goal.

In some examples, the local goal can be a short-term movement target point of the robot. The local goal is a target point to which the robot or vehicle should immediately move based on the way point, and can be a target point of a smaller unit than the way point.

The way point is a specific coordinate or position set as an intermediate stopover on a movement path. The way point is used by robots, vehicles, drones, game characters, etc., to follow a path to the target point.

The local path planning can be generating a short-term path for the robot or autonomous vehicle to move safely and efficiently from the current position to the destination.

The path planning unit 20 can include a local goal determination apparatus 100, a driving guide apparatus 200, a drivable area determination apparatus 300, and a local path planning generation apparatus 400.

The driving guide apparatus 200 can estimate the current position of the robot based on the GPS information on the non-precision map and determine the way point to the destination.

The drivable area determination apparatus 300 can detect an area in which the robot can drive and an area in which the robot may not drive using the sensor information.

The local goal determination apparatus 100 can determine a local goal from the current position based on information about the current position, the way point, and the drivable area.

The local path planning generation apparatus 400 can generate the local path planning for driving to a destination based on the local goal.

The robot control unit 30 can control the driving of the robot based on the local path planning received from the path planning unit.

The robot control unit 30 can include a robot control apparatus 500. The robot control apparatus 500 can be connected to the path planning unit through a network.

The robot control apparatus 500 can receive the local path planning from the local path planning generation apparatus 400. The robot control apparatus 500 can drive the robot to the destination based on the local path planning.

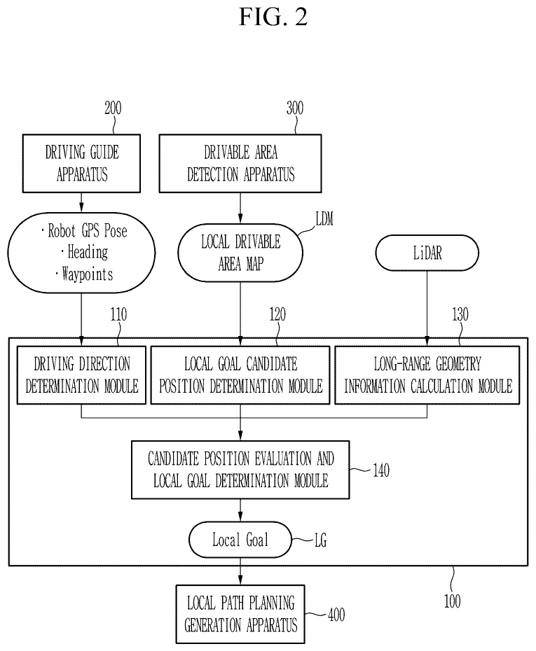

FIG. 2 is a block diagram illustrating an example of a local goal determination apparatus for non-precision map-based driving.

The local goal determination apparatus 100 for non-precision map-based driving according to an example implementation can execute program codes or instructions loaded in one or more memory devices through one or more processors.

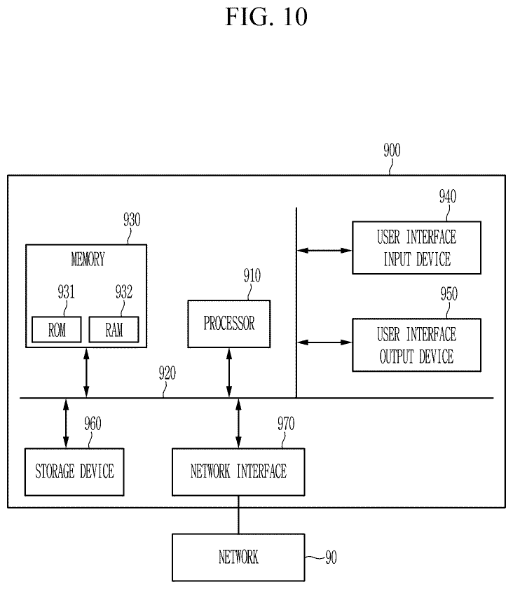

For example, the local goal determination apparatus 100 for non-precision map-based driving can be implemented as a computing device 900 as described below with reference to FIG. 10. In this case, one or more processors can correspond to a processor 910 of the computing device 900, and one or more memory devices can correspond to a memory 930 of the computing device 900.

The program code or instructions can be executed by one or more processors to determine a local goal based on a local goal candidate position, long-range geometry information, and a driving direction in which the robot should go, based on the current position of the robot driving based on the non-precision map. In this specification, the term “module” is used to logically distinguish these functions performed by the program code or instructions.

Referring to FIG. 2, the local goal determination apparatus 100 can include a driving direction determination module 110, a local goal candidate position determination module 120, a long-range geometry information calculation module 130, and a candidate position evaluation and local goal determination module 140.

The driving direction determination module 110 can receive the current position of the robot based on the robot GPS, the direction the robot is heading, and way points from the driving guide apparatus 200.

The driving direction determination module 110 can determine the driving direction in which the robot should go based on the current position and direction of the robot, and the way points.

The driving direction determination module 110 can determine the driving direction based on way points within a specific radius based on the estimated current position by considering the error between the estimated current position of the robot and the actual current position of the robot. For example, in some cases, the error is a predetermined or known value corresponding to an accuracy level of the estimation of a position of the robot using GPS.

The driving direction determination module 110 can calculate the driving direction by multiplying angular distributions for each of the plurality of way points.

In some examples, the angular distribution can be modeled as a normal distribution including a mean and a standard deviation.

The local goal candidate position determination module 120 can determine a plurality of local goal candidate positions based on the current position of the robot within the received adjacent drivable area.

The local goal candidate position determination module 120 can receive a local drivable area map (LDM) including an adjacent drivable area from the drivable area determination apparatus 300.

The local goal candidate position determination module 120 can determine local goal candidate positions that can be determined as local goals in the adjacent drivable area based on the local drivable area map (LDM).

The local goal candidate position determination module 120 can set a default drivable area of the robot.

The local goal candidate position determination module 120 can set a default drivable area as a rhombus-shaped area having vertices in front, straight left, straight right, and straight rear directions of the robot.

The local goal candidate position determination module 120 can generate an adjacent drivable area by coupling the local drivable area map and the default drivable area.

The local goal candidate position determination module 120 can calculate a contour of the adjacent drivable area and determine multiple local goal candidate positions among contour points of the calculated contour.

The local goal candidate position determination module 120 can include the vertices of the contour polygon defined by the contour, and the interpolated points between the vertices if the distance between the vertices is greater than or equal to the reference limit distance, in the multiple local goal candidate positions.

The long-range geometry information calculation module 130 can receive sensor information from LiDAR.

The long-range geometry information calculation module 130 can calculate the long-range geometry information using the sensor information.

The long-range geometry information can include data that a robot or autonomous vehicle recognizes and utilizes in advance the geometry and environment information of a distant area.

The long-range geometry information includes information collected in a wider range than data of the local sensor (close range).

The long-range geometry information calculation module 130 can generate a point cloud within a reference radius area based on the current position of the robot using the LiDAR sensor.

The long-range geometry information calculation module 130 can divide a reference radius area into multiple areas.

The long-range geometry information calculation module 130 can calculate an average distance from the current position of the robot to the point cloud for each of the multiple areas.

The long-range geometry information calculation module 130 can determine an average distance for a specific area that does not include a point cloud among the multiple areas as a length of the reference radius.

The candidate position evaluation and local goal determination module 140 can evaluate multiple local goal candidate positions based on the long-range geometry information and the driving direction and calculate an evaluation score.

The candidate position evaluation and local goal determination module 140 can finally determine the local goal candidate position with the largest calculated evaluation score as a local goal LG.

The candidate position evaluation and local goal determination module 140 can estimate geometry factors by interpolating long-range geometry information for each of multiple local goal candidate positions.

The candidate position evaluation and local goal determination module 140 can calculate an effective angle by subtracting the current direction angle from the driving direction angle.

The candidate position evaluation and local goal determination module 140 can calculate an effective distance between the robot and the local goal candidate position projected in the driving direction based on the actual distance and effective angle between the robot and the local goal candidate position.

The candidate position evaluation and local goal determination module 140 can produce an evaluation score by multiplying the geometry factor and the effective distance.

The candidate position evaluation and local goal determination module 140 can determine a specific local goal candidate position with the largest evaluation score as the local goal LG.

That is, the local goal determination apparatus 100 can receive the position of the robot, the heading direction of the robot based on the north, and the way points to the destination from the driving guide apparatus 200, and can receive the drivable area within a radius of 3 m as input from the drivable area determination apparatus 300.

The local goal determination apparatus 100 evaluates each of the local goal candidate positions using three pieces of information (local goal candidate position, long-range geometry information, direction in which the robot should go) obtained based on the inputs, determines the local goal candidate position with the highest score as the local goal LG, and transmits the determined local goal candidate position to the local path planning generation apparatus 400.

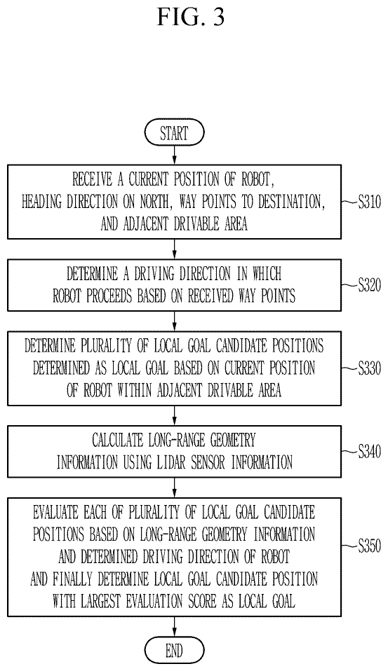

FIG. 3 is a flowchart illustrating an example of a local goal determination method for non-precision map-based driving. The local goal determination method for non-precision map-based driving can be performed through the local goal determination apparatus 100 for non-precision map-based driving of FIG. 2.

In FIG. 3, the local goal determination apparatus 100 for non-precision map-based driving can receive the current position of the robot, the heading direction based on the north, the way points to the destination, and the adjacent drivable area (step S310).

The local goal determination apparatus 100 for non-precision map-based driving can determine the driving direction that the robot should go based on the received way points (step S320).

The local goal determination apparatus 100 for non-precision map-based driving can determine the driving direction that the robot should go based on the current position and direction of the robot, and the way points.

The local goal determination apparatus 100 for non-precision map-based driving can determine the driving direction based on way points within a specific radius based on the estimated current position by considering the error between the estimated current position of the robot and the actual current position of the robot.

The local goal determination apparatus 100 for non-precision map-based driving can calculate the driving direction by multiplying angular distributions for each of a plurality of way points.

In some examples, the angular distribution can be modeled as a normal distribution including a mean and a standard deviation.

The local goal determination apparatus 100 for non-precision map-based driving can determine a plurality of local goal candidate positions that can be determined as local goals based on the current position of the robot within the adjacent drivable area (step S330).

The local goal determination apparatus 100 for non-precision map-based driving can receive a local drivable area map.

The local goal determination apparatus 100 for non-precision map-based driving can set a default drivable area of the robot.

The local goal determination apparatus 100 for non-precision map-based driving can set the default drivable area as the rhombus-shaped area having vertices in the front, straight left, straight right, and straight rear directions of the robot.

The local goal determination apparatus 100 for non-precision map-based driving can generate an adjacent drivable area by coupling the local drivable area map and the default drivable area.

The local goal determination apparatus 100 for non-precision map-based driving can calculate the contour of the adjacent drivable area.

The local goal determination apparatus 100 for non-precision map-based driving can determine multiple local goal candidate positions among the contour points of the calculated contour.

The local goal determination apparatus 100 for non-precision map-based driving can include the vertices of the contour polygon defined by the contour and the interpolated points between the vertices when the distance between the vertices is greater than or equal to a reference limit distance in multiple local goal candidate positions.

The local goal determination apparatus 100 for non-precision map-based driving can calculate the long-range geometry information using the LiDAR sensor information (step S340).

The local goal determination apparatus 100 for non-precision map-based driving can generate the point cloud within the reference radius area based on the current position of the robot using the LiDAR sensor.

The local goal determination apparatus 100 for non-precision map-based driving can divide the reference radius area into multiple areas.

The local goal determination apparatus 100 for non-precision map-based driving can calculate the average distance from the current position of the robot to the point cloud for each of the multiple areas.

The local goal determination apparatus 100 for non-precision map-based driving can determine the average distance as the length of a reference radius for a specific area among multiple areas that does not include the point cloud.

The local goal determination apparatus 100 for non-precision map-based driving can evaluate multiple local goal candidate positions based on the long-range geometry information and the determined driving direction of the robot (step S350).

For each of the multiple local goal candidate positions, the local goal determination apparatus 100 for non-precision map-based driving can estimate geometry factors by interpolating the long-range geometry information.

The local goal determination apparatus 100 for non-precision map-based driving can calculate an effective angle by subtracting an angle of a current direction from an angle of a driving direction.

The local goal determination apparatus 100 for non-precision map-based driving can calculate an effective distance between the robot and the local goal candidate positions projected in the driving direction based on the actual distance between the robot and the local goal candidate positions and the effective angle.

The local goal determination apparatus 100 for non-precision map-based driving can calculate an evaluation score by multiplying the geometry factors and the effective distance.

The local goal determination apparatus 100 for non-precision map-based driving can finally determine the local goal candidate position with the highest evaluation score as the local goal (step S350).

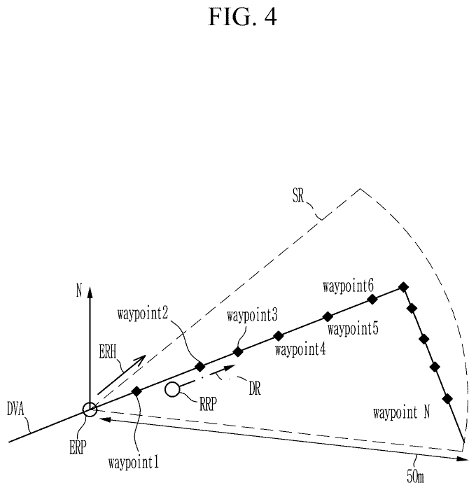

FIG. 4 is a diagram for describing an example of a method for determining a driving direction of a robot.

In FIG. 4, the local goal determination apparatus 100 for non-precision map-based driving can output a driving direction DR, which is a direction in which the robot should go, by inputting the estimated current position ERP, the estimated heading direction ERH, and way points way point_1 to way point_N on the path of the adjacent drivable area DVA of the robot.

For example, the local goal determination apparatus 100 for non-precision map-based driving can determine the driving direction by using way points within a specific radius SR (for example, 50 m) based on the estimated current position by considering the error between the estimated current position ERP and the actual current position RRP when determining the driving direction.

The local goal determination apparatus 100 for non-precision map-based driving can calculate the driving direction by multiplying all the angular distributions for each of the multiple way points way point_1 to way point_N.

The local goal determination apparatus 100 for non-precision map-based driving can calculate the driving direction that the robot should go through Equation 1.

$$Driving direction ( DR ) = N ( μ ( way point\_ 1 ) , σ ( way point\_ 1 ) ) \times ( N ( μ ( way point\_ 2 ) , σ ( way point\_ 2 ) ) \times … \times N ( μ ( way point\_N ) , σ ( way point\_N ) ) \qquad [ Equation 1 ]$$

Here, μ (way point_N) can be the average angle at way point N, σ (way point_N)) can be the standard deviation at way point N, and N (μ, σ) can represent a normal distribution with a mean μ and a standard deviation σ.

That is, N (μ(way point_N), σ(way point_N)) can be an angular distribution at way point N that follows a normal distribution.

The local goal determination apparatus 100 for non-precision map-based driving can calculate the average angle or the average angle distribution at way point N through Equation 2.

$$μ ( way point\_N ) = {θ}_{2} - {θ}_{1} \qquad [ Equation 2 ]$$

Here, θ₁ can be the angle between the estimated heading direction ERH and the true north direction, and θ₂ can be the angle between the line connecting the estimated current position ERP and way point_N and the true north direction.

The local goal determination apparatus 100 for non-precision map-based driving can calculate the standard deviation of the angle distribution through Equation 3.

$$σ ( way point\_N ) = \frac{d 1}{max - dist} \qquad [ Equation 3 ]$$

Here, max-dist is a preset limit radius SR, and d1 can be a distance between way point N and the estimated current position ERP of the robot.

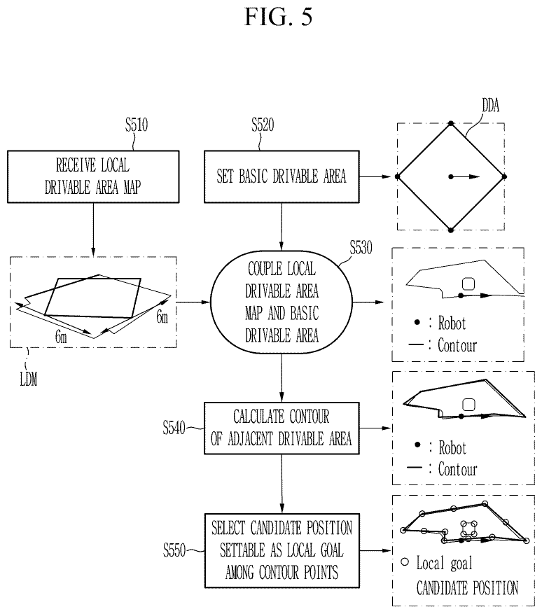

FIG. 5 is a diagram for describing an example of a method for determining a local goal candidate position. The method for determining a local goal candidate position can be performed through the local goal determination apparatus 100 for non-precision map-based driving (see FIG. 2).

In FIG. 5, the local goal determination apparatus 100 for non-precision map-based driving can receive a local drivable area map LDM including an adjacent drivable area (step S510).

The local goal determination apparatus 100 for non-precision map-based driving can set a default drivable area DDA (step S520).

The local goal determination apparatus 100 for non-precision map-based driving can set the default drivable area DDA as a rhombus in order to include the front, straight left, straight right, and straight rear directions of the robot as candidate positions when searching for local goal candidate positions.

The local goal determination apparatus 100 for non-precision map-based driving can combine the local drivable area map LDM and the default drivable area DDA (step S530).

The local goal determination apparatus 100 for non-precision map-based driving can calculate the contour of the adjacent drivable area (step S540).

The local goal determination apparatus 100 for non-precision map-based driving can select multiple candidate positions that can be set as local goals among contour points (step S550).

The local goal determination apparatus 100 for non-precision map-based driving assumes that candidate positions to be determined as local goals are arranged around the adjacent drivable area, and selects local goal candidate positions from among contour points.

The local goal determination apparatus 100 for non-precision map-based driving can determine a point interpolated between vertices as a candidate position when the distance between vertices of a contour polygon defined by the vertices of the contour is greater than or equal to a reference limit distance (for example, 1 m).

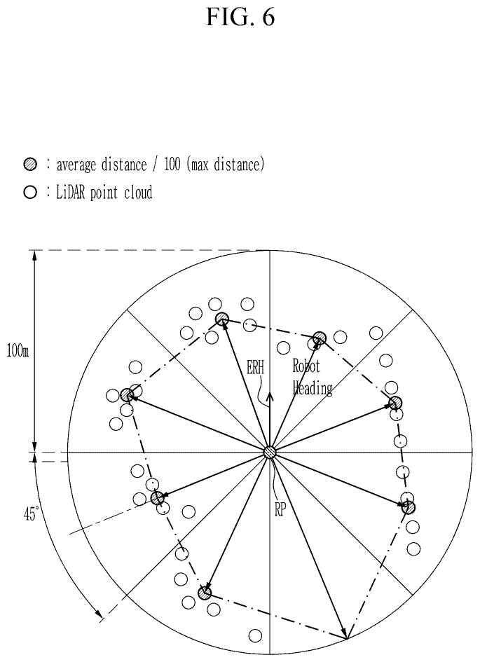

FIG. 6 is a diagram for describing an example of a method for calculating long-range geometry information.

The local goal determination apparatus 100 for non-precision map-based driving can determine long-range geometry information using sensor information received from LiDAR to prevent falling into a local minima area when only considering adjacent obstacles when evaluating local goal candidate positions.

In FIG. 6, the local goal determination apparatus 100 for non-precision map-based driving can output an average distance of obstacles within a reference radius area by inputting sensor information.

The local goal determination apparatus 100 for non-precision map-based driving can receive point cloud information (LiDAR point cloud) of obstacles within a reference radius area from a LIDAR sensor.

The local goal determination apparatus 100 for non-precision map-based driving can define a reference radius area (for example, within a distance of 100 m) including a point cloud (LiDAR point cloud) into a plurality of areas divided at a 45° angle.

The local goal determination apparatus 100 for non-precision map-based driving can calculate an average distance from the current position RP of the robot to the point cloud in each of the plurality of areas.

The local goal determination apparatus 100 for non-precision map-based driving can determine where large buildings are located around the current position RP of the robot and, accordingly, in which direction the robot can drive, using the calculated average distance.

The local goal determination apparatus 100 for non-precision map-based driving can calculate the average distance as 100 m in a specific area among multiple areas when there is no point cloud within 100 m of the specific area.

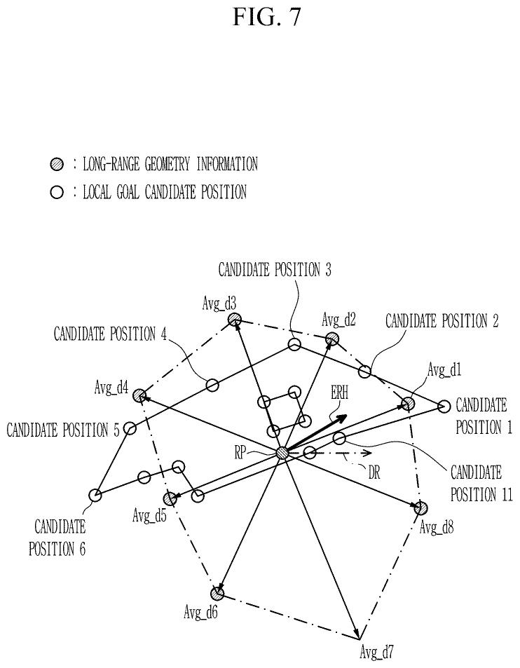

FIG. 7 to FIG. 9 are diagrams for describing an example of a method for evaluating a local goal candidate position and determining a local goal.

The local goal candidate position evaluation and local goal determination method can be performed by the local goal determination apparatus 100 for non-precision map-based driving of FIG. 2.

The local goal determination apparatus 100 for non-precision map-based driving can input the long-range geometry information, the local goal candidate positions, and the driving direction of the robot, and finally output the local goal of the robot.

FIG. 7 is a diagram illustrating an input that couples long-range geometry information Avg_d1 to Avg_d8, local goal candidate positions (candidate positions 1 to 11), the current position RP of the robot, the current direction ERH, and the driving direction DR of the robot.

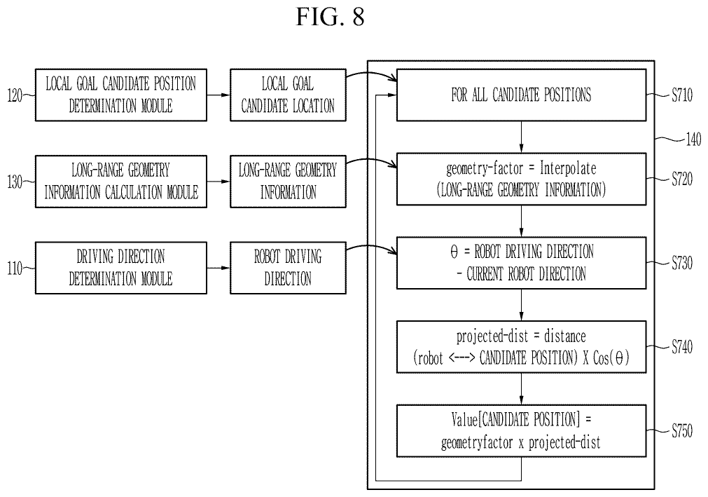

FIG. 8 is a flowchart for describing an evaluation method for calculating an evaluation score of a local goal candidate position and a local goal determination method.

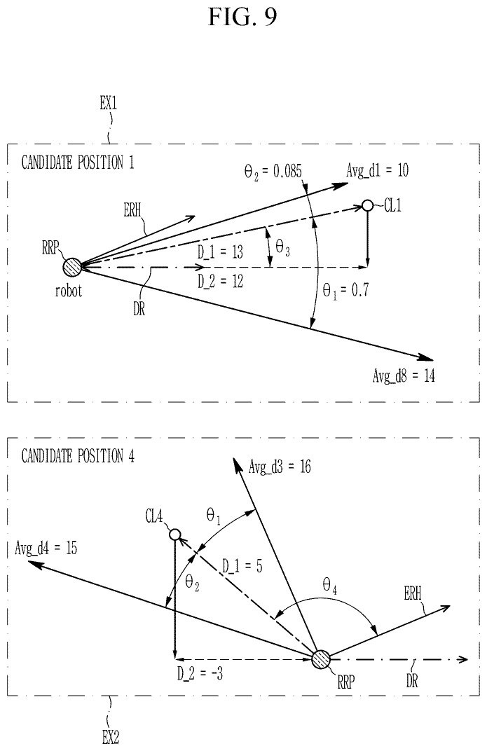

FIG. 9 is a diagram illustrating an example of calculating an evaluation score of a local goal candidate position according to the flowchart of FIG. 8.

In FIGS. 7 to 9, the local goal determination apparatus 100 for non-precision map-based driving evaluates the local goal candidate position using the driving direction DR that the robot should go, the local goal candidate position, and the long-range geometry information, and determines a candidate position with the highest score as the local goal.

In FIGS. 8 and 9, the local goal candidate position determination module 120 can determine a local goal candidate position and provide the determined local goal candidate position to the candidate position evaluation and local goal determination module 140.

The long-range geometry information calculation module 130 can calculate the long-range geometry information and provide the calculated long-range geometry information to the candidate position evaluation and local goal determination module 140.

The driving direction determination module 110 can determine the driving direction DR of the robot and provide the determined driving direction DR to the candidate position evaluation and local goal determination module 140.

The candidate position evaluation and local goal determination module 140 can calculate evaluation scores by repeating steps S720 to S750 for all of the determined multiple candidate positions (step S710).

The candidate position evaluation and local goal determination module 140 can estimate a geometry factor by interpolating the long-range geometry information (step S720).

The candidate position evaluation and local goal determination module 140 can calculate a geometry factor for a specific candidate position through Equation 4.

$$\frac{{θ}_{2} \times ( \frac{AvgDn}{100} ) + {θ}_{1} \times ( \frac{AvgDm}{100} )}{{θ}_{1} + {θ}_{2}} \qquad [ Equation 4 ]$$

Here, θ₁ can be an angle between a specific candidate position and adjacent long-range geometry information (AvgDn), and θ₂ can be an angle between a specific candidate position and adjacent other long-range geometry information (AvgDm).

In Example 1 EX1 of FIG. 9, the candidate position evaluation and local goal determination module 140 can calculate (0.7×0.1+0.085×0.14)/0.785≈0.104 as a geometry factor for candidate position 1 CL1 through Equation 4.

In Example 2 EX2 of FIG. 9, the candidate position evaluation and local goal determination module 140 can calculate (0.4×0.16+0.385×0.15)/0.785≈0.155 as a geometry factor for candidate position 4 CL1 through Equation 4.

The candidate position evaluation and local goal determination module 140 can calculate the effective angle θ between the driving direction DR of the robot and the current direction ERH (step S730).

The candidate position evaluation and local goal determination module 140 can determine, as the effective angle θ for candidate position 1 CL1, an angle obtained by subtracting an angle θ4 between the current direction ERH and the driving direction DR from the angle θ₃ between the driving direction DR and the candidate position.

The candidate position evaluation and local goal determination module 140 can calculate an effective distance D_2 between the robot and the local goal candidate position projected in the driving direction DR based on an actual distance D_1 and the effective angle θ between the current position RRP and the candidate position using Equation 5 (step S740).

$$projected - dist D \_ 2 = distance D\_ 1 \times cos ( θ ) \qquad [ Equation 5 ]$$

Here, projected-dist D_2 is the effective distance between the robot and the candidate position, distance D_1 is the actual distance D_1 between the current position RRP of the robot and the candidate position, and θ is the effective angle.

In Example 1 EX1 of FIG. 9, the effective distance D_2 of the candidate position 1 CL1 calculated by the candidate position evaluation and local goal determination module 140 through Equation 5 is 12.

In Example 2 EX2 of FIG. 9, the effective distance D_2 of a candidate position 4 CL4 calculated by the candidate position evaluation and local goal determination module 140 through Equation 5 is −3.

The candidate position evaluation and local goal determination module 140 can calculate an evaluation score (value) for a candidate position by multiplying a geometry factor and an effective distance (projected-dist D_2) (step S750).

In Example 1 EX1 of FIG. 9, the evaluation score of the candidate position 1 CL1 can be calculated as follows.

$$Value [ candidate position 1 ] = 0 \text{.1041} \times 2 = 1.248$$

In Example 2 (EX2) of FIG. 9, the evaluation score of candidate position 4 CL4 can be calculated as follows.

$$Value [ candidate position 4 ] = 0.155 \times - 3 = - 0.465$$

The candidate position evaluation and local goal determination module 140 can transmit the candidate position 1 CL1 as the final local goal to the local path planning generation apparatus 400 (see FIG. 2).

FIG. 10 is a diagram for describing a computing device.

Referring to FIG. 10, the local goal determination apparatus, method, and system for non-precision map-based driving according to the example implementations can be implemented using a computing device 900.

The computing device 900 can include at least one of a processor 910, a memory 930, a user interface input device 940, a user interface output device 950, and a storage device 960 that communicate via a bus 920. The computing device 900 can also include a network interface 970 that is electrically connected to a network 90. The network interface 970 can transmit or receive signals to and from other entities through the network 90.

The processor 910 can be implemented in various types such as a micro controller unit (MCU), an application processor (AP), a central processing unit (CPU), a graphic processing unit (GPU), a neural processing unit (NPU), and can be any semiconductor device that executes instructions stored in the memory 930 or the storage device 960. The processor 910 can be configured to implement the functions and methods described above with reference to FIGS. 1 to 9.

The memory 930 and the storage device 960 can include various types of volatile or non-volatile storage media. For example, the memory can include a read only memory (ROM) 931 and a random access memory (RAM) 932. In an example implementation of the present disclosure, the memory 930 can be positioned inside or outside the processor 910, and the memory 930 can be connected to the processor 910 through various ways.

In some example implementations, at least some components or functions of the local goal determination apparatus, method, and system for non-precision map-based driving according to the example implementations can be implemented as a program or software running on a computing device 900, and the program or software can be stored on a computer-readable medium.

In some example implementations, at least some components or functions of the local goal determination apparatus, method, and system for non-precision map-based driving according to the example implementations can be implemented using hardware or circuitry of the computing device 900, or can be implemented as separate hardware or circuitry that can be electrically connected to the computing device 900.

Although implementations of the present disclosure have been described in detail hereinabove, the scope of the present disclosure is not limited thereto, but can include several modifications and alterations made by those skilled in the art to which the present disclosure pertains using a basic concept of the present disclosure as defined in the claims.

What is claimed is:

1. A local goal determination apparatus for driving a robot based on a non-precision map, comprising:
one or more processors; and
one or more memory devices storing a program code configured to, based on being executed by the one or more processors, cause the local goal determination apparatus to perform operations comprising:
receiving a current position of the robot, a current direction of the robot, a plurality of way points to a destination, and an adjacent drivable area,
determining a driving direction for the robot to proceed based on the current position of the robot, the current direction of the robot, and the plurality of way points,
determining a plurality of local goal candidate positions within the adjacent drivable area based on the current position of the robot,
calculating long-range geometry information using sensor information,
evaluating each of the plurality of local goal candidate positions based on the long-range geometry information and the driving direction to determine an evaluation score of each of the plurality of local goal candidate positions, and
determining, as a local goal of the robot, one of the plurality of local goal candidate positions that has a greatest evaluation score among the evaluation scores of the plurality of local goal candidate positions.

2. The local goal determination apparatus of claim 1, wherein the current position of the robot is an estimated current position of the robot, and
wherein determining the driving direction comprises:
based on (i) the estimated current position of the robot and (ii) an error between the estimated current position of the robot and an actual current position of the robot, determining the driving direction based on way points among the plurality of way points that are located within a preset radius from the estimated current position.

3. The local goal determination apparatus of claim 2, wherein determining the driving direction further comprises:
multiplying angular distributions of the plurality of way points, each of the angular distributions corresponding to a normal distribution based on (i) a mean of an angle between the current direction of the robot and a line connecting the estimated current position and one of the way points within the preset radius and (ii) a standard deviation of the angle.

4. The local goal determination apparatus of claim 1, wherein determining the plurality of local goal candidate positions comprises:
receiving a local drivable area map;
setting a default drivable area of the robot;
coupling the local drivable area map and the default drivable area to generate the adjacent drivable area;
determining a contour of the adjacent drivable area; and
determining the plurality of local goal candidate positions among contour points of the contour.

5. The local goal determination apparatus of claim 4, wherein setting the default drivable area of the robot comprises:
setting, as the default drivable area, a rhombus-shaped area having vertices that are disposed at front, straight left, straight right, and straight rear positions of the robot.

6. The local goal determination apparatus of claim 4, wherein determining the plurality of local goal candidate positions among the contour points comprises:
adding, in the plurality of local goal candidate positions, (i) vertices of a contour polygon defined by the contour and (i) a point interpolated between the vertices based on a distance between the vertices being greater than or equal to a reference limit distance.

7. The local goal determination apparatus of claim 1, wherein calculating the long-range geometry information comprises:
generating a point cloud within a reference radius area based on the current position of the robot using a LIDAR sensor;
dividing the reference radius area into a plurality of areas;
calculating an average distance from the current position of the robot to the point cloud for each of the plurality of areas; and
determining the average distance as a length of a reference radius for a specific area that does not include the point cloud among the plurality of areas.

8. The local goal determination apparatus of claim 1, wherein evaluating each of the plurality of local goal candidate positions comprises:
for each of the plurality of local goal candidate positions, estimating a geometry factor by interpolating the long-range geometry information;
for each of the plurality of local goal candidate positions, calculating an effective angle by subtracting an angle of the current direction relative to a reference direction from an angle of the driving direction relative to the reference direction;
calculating an effective distance between the robot and one of the plurality of local goal candidate positions projected in the driving direction based on (i) an actual distance between the robot and the one of the plurality of local goal candidate positions and (ii) the effective angle; and
calculating the evaluation score for each of the plurality of local goal candidate positions by multiplying the geometry factor and the effective distance.

9. A local goal determination method for driving a robot based on a non-precision map, the local goal determination method being performed by a computing device including a processor and a memory, the local goal determination method comprising:
receiving a current position of the robot, a current direction of the robot, a plurality of way points to a destination, and an adjacent drivable area;
determining a driving direction for the robot to proceed based on the current position of the robot, the current direction of the robot, and the plurality of way points;
determining a plurality of local goal candidate positions within the adjacent drivable area based on the current position of the robot;
calculating long-range geometry information using sensor information;
evaluating each of the plurality of local goal candidate positions based on the long-range geometry information and the driving direction to determine an evaluation score of each of the plurality of local goal candidate positions; and
determining, as a local goal of the robot, one of the plurality of local goal candidate positions that has a greatest evaluation score among the evaluation scores of the plurality of local goal candidate positions.

10. The local goal determination method of claim 9, wherein the current position of the robot is an estimated current position of the robot, and
wherein determining the driving direction comprises:
based on (i) the estimated current position of the robot and (ii) an error between the estimated current position of the robot and an actual in current position of the robot, determining the driving direction based on way points among the plurality of way points that are located within a preset radius from the estimated current position.

11. The local goal determination method of claim 10, wherein determining the driving direction further comprises:
multiplying angular distributions of the plurality of way points, each of the angular distributions corresponding to a normal distribution based on (i) a mean of an angle between the current direction of the robot and a line connecting the estimated current position and one of the way points within the preset radius and (ii) a standard deviation of the angle.

12. The local goal determination method of claim 9, wherein determining the plurality of local goal candidate positions comprises:
receiving a local drivable area map;
setting a default drivable area of the robot;
coupling the local drivable area map and the default drivable area to generate the adjacent drivable area;
determining a contour of the adjacent drivable area; and
determining the plurality of local goal candidate positions among contour points of the contour.

13. The local goal determination method of claim 12, wherein setting the default drivable area of the robot comprises:
setting, as the default drivable area, a rhombus-shaped area having vertices that are disposed at front, straight left, straight right, and straight rear positions of the robot.

14. The local goal determination method of claim 12, wherein determining the plurality of local goal candidate positions among the contour points comprises:
adding, in the plurality of local goal candidate positions, (i) vertices of a contour polygon defined by the contour and (i) a point interpolated between the vertices based on a distance between the vertices being greater than or equal to a reference limit distance.

15. The local goal determination method of claim 9, wherein calculating the long-range geometry information comprises:
generating a point cloud within a reference radius area based on the current position of the robot using a LIDAR sensor;
dividing the reference radius area into a plurality of areas;
calculating an average distance from the current position of the robot to the point cloud for each of the plurality of areas; and
determining the average distance as a length of a reference radius for a specific area that does not include the point cloud among the plurality of areas.

16. The local goal determination method of claim 9, wherein evaluating each of the plurality of local goal candidate positions comprises:
for each of the plurality of local goal candidate positions, estimating a geometry factor by interpolating the long-range geometry information;
for each of the plurality of local goal candidate positions, calculating an effective angle by subtracting an angle of the current direction relative to a reference direction from an angle of the driving direction relative to the reference direction;
calculating an effective distance between the robot and each of the plurality of local goal candidate positions projected in the driving direction based on (i) an actual distance between the robot and one of the plurality of local goal candidate positions and (ii) the effective angle; and
calculating the evaluation score for each of the plurality of local goal candidate positions by multiplying the geometry factor and the effective distance.

17. A local goal determination system for driving a robot based on a non-precision map, comprising:
a sensor unit comprising GPS, LiDAR, and a plurality of cameras;
a path planning unit configured to:
receive the non-precision map,
based on the non-precision map and sensor information received from the sensor unit, determine an adjacent drivable area, way points to a destination, and a local goal of the robot, and
generate a local path plan based on the local goal; and
a robot control unit configured to control driving of the robot based on the local path plan received from the path planning unit.

18. The local goal determination system of claim 17, wherein the path planning unit comprises one or more processors configured to:
estimate a current position of the robot in the non-precision map based on GPS information and to determine the way points to the destination;
using the sensor information, determine (i) the adjacent drivable area that is an area available for the robot to travel and (ii) an area that is unavailable for the robot to travel;
determine the local goal for the robot based on information on the current position, the way points, and the drivable area; and
generate a local path planning for driving to the destination based on the local goal.

19. The local goal determination system of claim 18, wherein the one or more processors are further configured to:
determine a driving direction for the robot to proceed based on the current position of the robot, a current direction of the robot, and the way points;
determine a plurality of local goal candidate positions in the adjacent drivable area based on the current position of the robot;
calculate long-range geometry information using the sensor information;
evaluate each of the plurality of local goal candidate positions based on the long-range geometry information and the driving direction to determine an evaluation score of each of the plurality of local goal candidate positions; and
determine, as the local goal of the robot, one of the plurality of local goal candidate positions that has a greatest evaluation score among the evaluation scores of the plurality of local goal candidate positions.

20. The local goal determination system of claim 19, wherein the one or more processors are further configured to:
for each of the plurality of local goal candidate positions, estimate a geometry factor by interpolating the long-range geometry information;
for each of the plurality of local goal candidate positions, calculate an effective angle by subtracting an angle of the current direction relative to a reference direction from an angle of the driving direction relative to the reference direction;
calculate an effective distance between the robot and each of the plurality of local goal candidate positions projected in the driving direction based on (i) an actual distance between the robot and one of the plurality of local goal candidate positions and (ii) the effective angle; and
calculate the evaluation score for each of the plurality of local goal candidate positions by multiplying the geometry factor and the effective distance.
